(19) United States
(12) Patent Application Publication
(10) Pub. No.: US 2016/0035448 A1
(43) Pub. Date: Feb. 4, 2016

(54) PRODUCTION OF CARBON-11 USING A LIQUID TARGET

(71) Applicant: GENERAL ELECTRIC COMPANY, Schenectady, NY (US)

(72) Inventors: Tiberiu Mircea Siclovan, Rexford, NY (US); Peter Andras Zavodszky, Clifton Park, NY (US)

(21) Appl. No.: 14/448,943

(22) Filed: Jul. 31, 2014

(51) Int. Cl. G21G 1/00

(52) U.S. Cl. CPC G21G 1/001; G21G 2001/0094

(57) ABSTRACT

The present disclosure relates to the generation of radioisotopes, includes 11-carbon, from liquid targets. In certain embodiments, a liquid hydrazine target is employed which, when irradiated, such as with a charged particle beam, generates 11-carbon in a form that may be recovered and used in downstream processes, such as the generation of radiopharmaceuticals.

### BACKGROUND

The subject matter disclosed herein relates generally to the field of isotope generation, such as the generation of carbon-11 (¹¹C) using a cyclotron, including a miniature cyclotron.

Non-invasive imaging technologies allow images of the internal structures of a patient or object to be obtained using various radiological principles that do not necessitate that an invasive procedure be performed on the patient or object. For example, structural images, such as of the internal arrangement of bones and organs, are typically visible using techniques such as magnetic resonance imaging (MRI), X-ray, and computed tomography (CT). These techniques may also be modified in some instances to produce functional images, i.e., images depicting the metabolic or pharmacokinetic behavior of the patient. However, functional images obtained by nuclear medicine imaging techniques are often superior because of the higher signal to noise ratio than images obtained by other means.

Examples of nuclear medicine imaging techniques include single photon emission computed tomography (SPECT) and positron emission tomography (PET). The nuclear medicine imaging techniques typically measure the decay of a radiopharmaceutical that is preferentially taken up by an organ or system of interest. As the radiopharmaceutical decays, it emits gamma rays of sufficient energy to escape the body which may be detected on a gamma ray detector that is a component of a SPECT or PET imaging system. The measured gamma rays can be used to formulate diagnostically useful functional images. For example, the functional images may describe the uptake and processing of the pharmacologic agent by the organ or system of interest.

The radiopharmaceutical giving rise to these gamma rays is generally a pharmaceutical agent attached to or incorporating a radioisotope that is subject to radioactive decay. Upon decay of the radioisotope, the gamma rays are emitted and subsequently measured outside the patient's body. The selection of the radioisotope is generally based upon a variety of factors. Among these factors are the chemical properties and the useful lifespan of the radioisotope. Due to the relatively short useful life of the radioisotope, the radioisotope may be prepared at a local or regional facility using a cyclotron to accelerate particles to velocities suitable for inducing the desired nuclear reactions.

One such isotope is carbon-11 (¹¹C), which decays to boron-11 via positron emission and which may be used in such nuclear imaging techniques. The half-life of ¹¹C, however, is only in the range of twenty minutes, necessitating production at or very near the site at which it will be used. Such local or on-site production may be best suited for the use of small or reduced size cyclotrons. However, production may be stymied due to the lack of suitable starting materials which would allow production of a suitable batch or dose of ¹¹C from a limited amount of starting material, which might be best suited for use in such a miniature or reduced-size cyclotron.

### BRIEF DESCRIPTION

In one embodiment, a method for generating a radioisotope is provided. In accordance with this method, a liquid hydrazine target is irradiated with a beam of charged particles.

In a further embodiment, a method is provided for generating ¹¹C. In accordance with this method, a cyclotron target is loaded with liquid hydrazine. A charged particle beam is directed at the cyclotron target to generate an irradiated product. The irradiated target includes ¹¹C. The irradiated product is recovered from the cyclotron target.

In an additional embodiment, a cyclotron target is provided. The cyclotron target includes a foil and a body that, in conjunction with the foil, defines a target material cavity. The cyclotron target also includes a quantity of liquid hydrazine disposed in the target material cavity.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a diagrammatic representation of a cyclotron, in accordance with one aspect of the present approach;

FIG. 2 is a schematic of a liquid target irradiation process for generating radioisotopes, in accordance with one aspect of the present approach;

FIG. 3 is a process flow diagram illustrating steps in the generation, recovery, and use of ¹¹C, in accordance with one aspect of the present approach; and

FIG. 4 is a process flow diagram illustrating steps in the generation, recovery, and use of ¹¹C, in accordance with a further aspect of the present approach.

### DETAILED DESCRIPTION

One or more specific embodiments will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Furthermore, any numerical examples in the following discussion are intended to be non-limiting, and thus additional numerical values, ranges, and percentages are within the scope of the disclosed embodiments.

In certain nuclear imaging procedures, it may be desirable to use radioisotopes having short half-lives (e.g., a half-life in the range of twenty minutes). One such radioisotope is carbon-11 (¹¹C). One advantage of ¹¹C is that the chemical nature of radiopharmaceuticals incorporating ¹¹C is identical to that of the corresponding ¹²C/¹³C (i.e., natural abundance or “cold”) compound. By contrast, radiopharmaceuticals obtained by replacing a monovalent group (such as H or OH) with an ¹⁸F (e.g. FDG vs. glucose) are chemically different and must undergo validation of their suitability for the intended imaging procedure. Consequently, by using ¹¹C one has access to a wider array of radiopharmaceuticals, based on the natural biochemistry of the pathway under investigation. Due to the short half-life of ¹¹C, it is generally desirable to generate this radioisotope at or near the site where it will be used. Further, due to the short half-life, it may be desirable to only produce one or two doses at a time to avoid waste and decay of unused radioisotope.

In the case of nuclear imaging, this generally means generating the radioisotope within the health care facility (e.g., hospital or imaging center) and perhaps even within the examination suite. Indeed, in practice a miniature cyclotron may be employed at the facility or at the imaging site that is capable of producing a variety of different radioisotopes (e.g., ¹¹C, ¹⁸F, ¹³N, ¹⁵O, and so forth) on demand in quantities or concentrations suitable for single dose preparations, thus improving the efficiency of the overall imaging infrastructure of a facility.

One problem associated with generating ¹¹C in this manner is the lack of an efficient starting or precursor material. In particular, gaseous precursors are insufficiently dense to allow efficient production of ¹¹C in such a small or miniature cyclotron environment. That is, use of a small or miniature cyclotron involves use of a correspondingly small target, with a gaseous target being insufficiently dense to generate a sufficient amount or concentration of radioisotope. However, known non-gaseous (i.e., solid or liquid) precursors typically are either inefficient for use in such small scale systems or produce a range of different isotopes, only some of which are the target radioisotope.

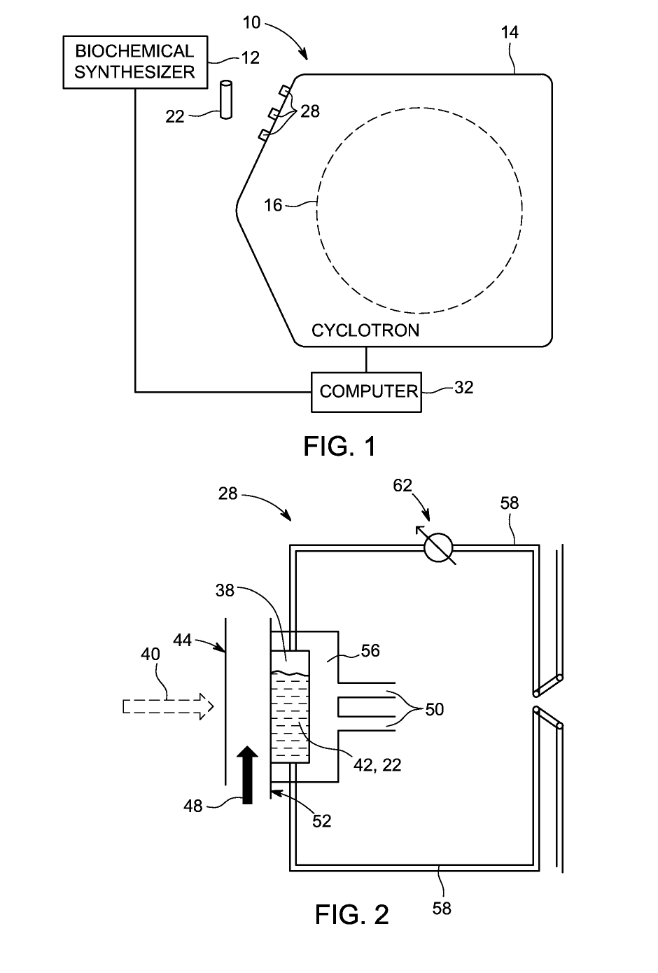

With the preceding in mind, and turning to FIG. 1, a generalized example of an equipment layout is depicted that is suitable for generating ¹¹C as discussed herein. In this example, a particle accelerator, in the form of a cyclotron 10 is depicted. Due to the short half-life of certain radioisotopes of interest, i.e., the time it takes for half of the sample of radioisotope to decay, the cyclotron 10 may be on-site relative to where the examination will occur (i.e., within or near to the hospital or imaging center). Incorporation of the radioisotope generated using the cyclotron 10 into an imaging agent (e.g., a radiopharmaceutical) may occur in a biochemical synthesizer 12. In certain embodiments, the synthesizer 12 may be connected to the cyclotron 10, though in other embodiments the synthesizer 12 may be separate and apart from the cyclotron 10, such as in an examination suite or on a different level of the hospital. That is, in certain implementations the cyclotron 10 may be at one location, such as in the basement of a hospital, while the synthesizer 12 is at a different location, such as at the site where the imaging examination will be performed. In such an implementation, the radioisotope 8 generated at the cyclotron 10 may be carried to the location of the synthesizer 12 for synthesis of the radiopharmaceutical.

In practice, the cyclotron 10 includes a magnet yoke surrounding an acceleration chamber 16, within which a vacuum is maintained. The opposing poles of the magnet yoke are spaced apart from one another and generate a static magnetic field. Accelerating electrodes (i.e., “dees”) are present inside the vacuum chamber and are connected to a high voltage radiofrequency (RF) power supply. This rapidly changing RF field is used to accelerate ions injected from an ion source onto the spiral path. Once the charged particles are accelerated to the desired velocity (energy), they are directed to one or more targets 28 containing the material to be irradiated, such as a liquid hydrazine precursor, as discussed herein. The charged particles react with the liquid precursor material in the targets 28 to generate radioisotopes, such as ¹¹C, that may be incorporated with other compounds in the biochemical synthesizer 12 to generate a radiopharmaceutical of interest. For illustration, the radioisotope 22 in FIG. 1 is shown after extraction from the target structures 28, such as for transport to the synthesizer 12.

In order to have a sufficiently small-sized cyclotron 10 with the capability of accelerating hydrogen ions to the approximately 12 MeV necessary for efficient production of the short lived positron emitter radioisotopes of ¹¹C and ¹³N, the magnetic field inside the cyclotron 10 should be about 4-6 Tesla. This magnetic field is high enough to cause substantial amount of Lorentz stripping if the accelerated ion is H⁻. For this reason the accelerated ion is preferably H⁺ in certain embodiments. Accelerating H⁺ charged particles eases the high vacuum requirement in the cyclotron vacuum tank but makes extraction of a H⁺ beam from the cyclotron 10 difficult due to the limited space available in a mini cyclotron 10. In a positive ion cyclotron, extraction of the accelerated beam is typically accomplished with electrostatic deflector electrodes biased at high voltage. Without an extracted beam, the radioisotope producing target has to be an internal target. The advantage of using an internal target is that the fully accelerated beam can be used for radioisotope production without losses attributable to beam extraction and the radiation shielding supplied by the cyclotron structural elements (e.g., the return iron yoke of the magnet). The disadvantage of the internal target, however, is the limited space available for the target hardware. Such space limitations are attributable not only to the limited size of the cyclotron 10, but also to the need to not interfere with the accelerating structure inside the cyclotron 10.

In a conventional medical cyclotron, the charged particle beam may be extracted to different target ports 28 by mechanically moving a stripper foil inside the cyclotron vacuum tank to different pre-established positions. The charged particle beam in such an implementation may be extracted using the stripper foil (e.g., a carbon foil, not shown), which strips two electrons from the H⁻ ion to generate an H⁺ ion. The H⁺ ion is pushed out by the Lorentz force in the magnetic field, which changes sign and is oriented radially outward (compared to the radially inward orientation before the stripping). In alternative implementations, the H+ ion may be extracted by stripping through one beam port and using a switching magnet downstream to distribute the extracted beam to different target stations 28. In a mini cyclotron without an extracted beam, interchangeable target inserts may instead be employed, which may be inserted to the same location in the cyclotron vacuum tank or which may use the same target holder which would be purged before switching to different target materials to produce a different radioisotope.

As noted above, the need for a reduced size target in a small or miniature cyclotron context may preclude the use of gaseous precursor materials, hence the use of a liquid precursor target material, such as liquid hydrazine noted above, allows for an efficient radioisotope generation process. By way of example, a sufficient gaseous target may need a path length in the tens of centimeters to allow sufficient generation of the desired radioisotope, while a comparable liquid target may only need a path length in the range of a few millimeters to a few centimeters (e.g., less than 1 cm, less than 5 cm, or less than 10 cm). Such a reduced path length, and correspondingly reduced target vessel size, is more suitable for use with a miniature cyclotron 10.

A computer 32 may be connected to the cyclotron 10 to monitor and/or control the operation of the device. The computer may coordinate operation of the ion source, the electromagnet, the RF amplifier or other components of the cyclotron 10. The computer 32 may also, for example, coordinate the motion of the extraction mechanism within the cyclotron 10 such that the emerging particle beam may be steered between multiple targets 28. In this manner, different or additional targets may be processed as desired. In the depicted example, the computer 32 is also in communication with the synthesizer 12, though this will likely not be the case when the synthesizer 12 and cyclotron 10 are not collocated or otherwise near one another. Further, even when collocated, separate or different computers 32 or controllers may be employed to operate the cyclotron 10 and synthesizer 12.

It should be appreciated that, in certain embodiments, the cyclotron 10 may be a miniature or small cyclotron sized to fit within a room near the examination site. By way of example, a cyclotron 10 implemented in a miniature or small form factor may have a footprint of no more than (and typically less than) 1 m by 1 m. Further, in certain implementations, the cyclotron 10 may be configured to receive a variety of different target vessels, containing different precursor materials, and to thereby generate a variety of different radioisotopes (including ¹¹C as discussed herein) upon receiving appropriate instructions from a user, such a via computer 32). For example, the cyclotron 10, in response to commands issued by the computer 32, may be automated in terms of loading a target vessel containing a suitable precursor material into a target area 28 or receptacle, applying a charged particle beam of the appropriate strength and duration to the precursor material, and unloading the target vessel upon completion of the irradiation protocol. Further automation may be provided in terms of extracting, purifying, or reacting the materials extracted from the target vessel so as to generate the desired radioisotope in a useful concentration and quantity. Thus, in such an arrangement, a user may select for the production of a given radioisotope (e.g., ¹¹C) from an interface displayed at the computer 32, and in response to this selection, the computer 32 may execute stored routines to cause the loading of a suitable target and precursor material to the cyclotron 10, to cause the irradiation of the precursor material by the cyclotron 10 in accordance with a defined irradiation protocol, and to dispense the selected radioisotope (in a purified, or unpurified form) after completion of the irradiation protocol. In the context of an interconnected synthesizer 12, the generated radioisotope may be provided automatically to the synthesizer 12, though in other embodiments a user may be involved in retrieving the generated radioisotope and providing the radioisotope to the synthesizer.

By way of further example, and turning to FIG. 2, a schematic of charged particle bombardment of a liquid target in a suitable targeting arrangement is depicted. In this example, an ion beam 40 generated by the cyclotron 10 is directed to a liquid target 42 (e.g., liquid hydrazine) within a targeting chamber 28 provided adjacent to the cyclotron 10. In the depicted example, the ion beam passes through a foil interface, i.e., cyclotron foil 44, which forms the vacuum barrier between the high vacuum inside the cyclotron vacuum tank and the target hardware. In the depicted example, helium gas 48 may be flowed between the cyclotron foil 44 and the target vessel to provide cooling. In other embodiments, the cyclotron foil 44 and helium cooling may be absent and cooling may instead be provided by liquid used as the target material.

As shown in FIG. 2, in one implementation, the liquid target 42 (e.g., liquid hydrazine) may be provided in a narrow chamber 38 (e.g., less than 1 cm across perpendicular to the direction of the ion beam 40) defined on the side facing the ion beam 40 by target foil 52 (such as a metal foil or alloy disc formed from a heat treatable cobalt base alloy and having a thickness between 5 μm and 50 μm). One suitable material that may be used to form one or both of the cyclotron foil 44 (if present) and target foil 52 is Havar, due to the mechanical strength provided by this alloy even at the elevated temperatures produced by the extracted beam bombardment.

The chamber 38 may be sized to hold a suitable amount of the liquid target material 42 for irradiation, such as between 0.5 ml to 3 ml (e.g., about 1.0 ml, 1.5 ml, 2.0 ml, or 2.5 ml). The remainder of the target vessel body 56 may be formed from a suitable composition, such as a Niobium composition. In certain embodiments, channels and/or other passages 50 may be provided to circulate a coolant, such as water, about the target chamber. In addition, passages 58 may be provided for loading the target chamber 38 with target material 42 (e.g., liquid hydrazine) or of unloading the irradiated material containing the desired radioisotope 22. In such implementations, a pressure gauge 62 may be provided to facilitate the pressure assisted loading and unloading of the chamber 38. In certain embodiments, the target chamber 28 may be constructed so as to be removably engaged and disengaged from the cyclotron 10, while in other implementations the target chamber 28 may be generally affixed to the cyclotron 10.

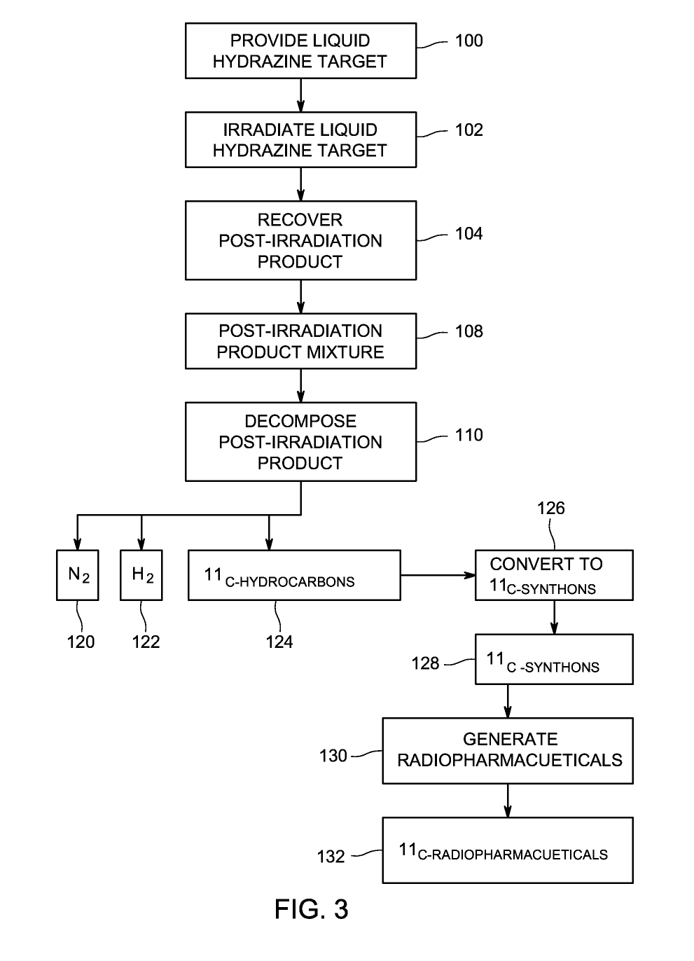

While the preceding describes certain structural features of a cyclotron 10 and targeting chamber 28 suitable for processing a liquid target material 42 to generate a desired radioisotope 22, the following describes one such implementation suitable for generating ¹¹C. In particular, as noted above, in one embodiment (turning to FIG. 3) the precursor material used in the generation of ¹¹C is liquid hydrazine (N₂H₄) (provided at block 100) which undergoes proton irradiation (i.e., H+ irradiation) (block 102) when provided as a liquid target 42 of a cyclotron 10. In such an implementation, the precursor material of hydrazine includes only hydrogen (H) and the nucleus of interest, nitrogen (N). In one embodiment, the hydrazine may be provided in a niobium-Havar target chamber, as described above, and, when proton irradiated, undergoes the following nuclear reaction:

¹⁴N+¹H⁺→¹¹C+⁴He (1)

The contents of the post-irradiation target chamber, i.e., the resulting irradiation product 108 or composition, may be recovered (block 104) and decomposed (block 110), such as over an iridium catalyst, to yield N₂ (120), H₂ (122), and ¹¹C-hydrocarbons (124). From this point, ¹¹C-methane may be converted (block 126) to ¹¹C-synthons (128) suitable for radiopharmaceutical (132) generation (block 130) (such as at synthesizer 12) using known conversion routes.

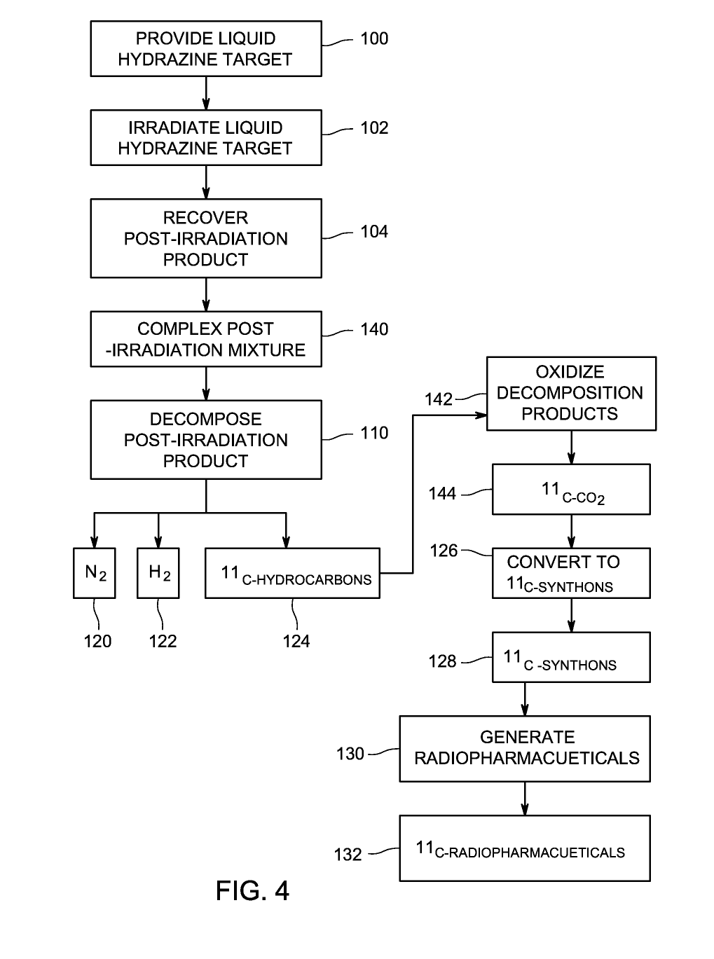

Turning to FIG. 4, should the ¹¹C produced by hydrazine proton irradiation be present in a chemically complex mixture (140) additional steps may be employed in order to obtain ¹¹C in a form suitable for radiopharmaceutical production. For example, in certain embodiments, following the catalytic decomposition of the excess hydrazine over an iridium catalyst, the resultant gaseous mixture may be oxidized (e.g., burned) (block 142) to yield ¹¹C—CO₂ (144) which may then be converted (block 126) to ¹¹C-synthons (128) using known techniques.

Technical effects of the invention include, but are not limited to, the generation of ¹¹C using a liquid target material, such as hydrazine. Other technical effect include the generation of ¹¹C using a miniature cyclotron and/or a target suitable for use in a miniature cyclotron. Further technical effects include the production of radiopharmaceuticals incorporating ¹¹C generated from a hydrazine precursor.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method for generating a radioisotope, comprising:
irradiating a liquid hydrazine target with a beam of charged particles.

2. The method of claim 1, further comprising:
recovering the irradiated liquid hydrazine target; and
decomposing the irradiated liquid hydrazine target to recover ¹¹C-hydrocarbons.

3. The method of claim 2, wherein decomposing the irradiated liquid hydrazine comprises exposing the irradiated liquid hydrazine to an iridium catalyst.

4. The method of claim 2, comprising converting the ¹¹C-hydrocarbons to ¹¹C-synthons.

5. The method of claim 4, comprising incorporating the ¹¹C-synthons into a radiopharmaceutical.

6. The method of claim 2, comprising oxidizing at least the ¹¹C-hydrocarbons to generate ¹¹C—CO₂.

7. The method of claim 6, comprising converting the ¹¹C—CO₂ to ¹¹C-synthons.

8. The method of claim 7, comprising incorporating the ¹¹C-synthons into a radiopharmaceutical.

9. A method for generating ¹¹C, comprising:
loading a cyclotron target with liquid hydrazine;
directing a charged particle beam at the cyclotron target to generate an irradiated product, wherein the irradiated target comprises ¹¹C; and
recovering the irradiated product from the cyclotron target.

10. The method of claim 9, wherein the cyclotron target is loaded into a miniature cyclotron.

11. The method of claim 10, wherein the miniature cyclotron has a footprint of approximately 2 m by 2 m or less.

12. The method of claim 9, wherein the cyclotron target is loaded with between about 0.5 ml to about 3.0 ml of liquid hydrazine.

13. The method of claim 9, wherein the cyclotron target has a width of less than 5 cm in the direction traveled by the charged particle beam.

14. The method of claim 9, further comprising:
decomposing the irradiated product to one or more constituents, one of which is ¹¹C-hydrocarbons.

15. The method of claim 14, further comprising:
generating ¹¹C-synthons from the ¹¹C-hydrocarbons or from an oxidation byproduct of the ¹¹C-hydrocarbons; and
synthesizing radiopharmaceuticals using the ¹¹C-synthons.

16. The method of claim 9, wherein the cyclotron target comprises a Niobium-Havar construct.

17. The method of claim 9, wherein the cyclotron target is loaded and unloaded automatically in response to selections made at a computer in communication with the cyclotron.

18. A cyclotron target, comprising:
a foil;
a body that, in conjunction with the foil, defines a target material cavity; and
a quantity of liquid hydrazine disposed in the target material cavity.

19. The cyclotron target of claim 17, wherein the foil comprises a Havar foil.

20. The cyclotron target of claim 17, wherein the body comprises Niobium.
